(19) United States
(12) Patent Application Publication
(10) Pub. No.: US 2026/0147691 A1
(43) Pub. Date: May 28, 2026

(54) SYSTEMS AND METHODS FOR GENERATION OF AUTOMATED TESTING TOOLS FOR SOFTWARE APPLICATIONS

(71) Applicant: BANK OF AMERICA CORPORATION, Charlotte, NC (US)

(72) Inventors: Manu Jacob Kurian, Dallas, TX (US); Jamie Phipps, London (GB); Aeric John Solow, Allen, TX (US)

(73) Assignee: BANK OF AMERICA CORPORATION, Charlotte, NC (US)

(21) Appl. No.: 18/956,424

(22) Filed: Nov. 22, 2024

(51) Int. Cl. G06F 11/36

(52) U.S. Cl. CPC G06F 11/3684; G06F 11/368; G06F 11/3698

(57) ABSTRACT

Systems, computer program products, and methods are described herein for a generation of automated testing tools for software applications. The present disclosure is configured to collect software code data associated with at least one software code or system component comprising the at least one software code; apply the software code data to a generative artificial intelligence (AI) engine; generate, by the generative AI engine, connections between the software code data; and generate, based on the connections between the software code data and by the generative AI engine, at least one test script for the at least one software code or the system component, wherein the test script file comprises an end-to-end test for the software code and associated software programs connected to the software code.

### TECHNOLOGICAL FIELD

Example embodiments of the present disclosure relate to a generation of automated testing tools for software applications.

### BACKGROUND

In today's world of software applications and electronic devices to complete everyday tasks and activities, making sure those software applications and electronic devices are operating correctly and efficiently is of utmost importance. In order to make sure these software applications and devices are working optimally; test script files are generated to test these applications and devices both before they enter a production environment and continuously after the application has been introduced to production. One major pitfall with these test script files are their inability to accurately simulate the real-world production environment that the application and device are actually in use, and thus, these test script files fail to test the applications and devices for real-world issues each will face which in turn leads to the applications and devices performing non-optimally or not at all in the real-world environments. Thus, there exists a great need for a system, computer program product, and/or computer implemented method that can efficiently, automatically, and dynamically generate these test scripts to be as close to these real-world production environments as possible.

Applicant has identified a number of deficiencies and problems associated with automatically generating test scripts. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for a generation of automated testing tools for software applications.

In one aspect a system for a generation of automated testing tools for software applications is provided. In some embodiments, the system may comprise: a memory device with computer-readable program code stored thereon; at least one processing device operatively coupled to the memory device and at least one communication device, wherein executing the computer-readable code is configured to cause the at least one processing device to: collect software code data associated with at least one software code or system component comprising the at least one software code; apply the software code data to a generative artificial intelligence (AI) engine; generate, by the generative AI engine, connections between the software code data; and generate, based on the connections between the software code data and by the generative AI engine, at least one test script for the at least one software code or the system component, wherein the test script file comprises an end-to-end test for the software code and associated software programs connected to the software code.

In some embodiments, the software code data is collected from a plurality of disparate software code sources.

In some embodiments, the software code data comprises production data, software development data, user experience data, current test script data, and production support data.

In some embodiments, the software code data comprises production data, wherein executing the computer-readable code is further configured to cause the at least one processing device to: analyze, by the generative AI engine, the production data of the at least one software code or the system component; determine, by the generative AI engine, at least one latency period for the at least one software code or the system component; and update, by the generative AI engine, the at least one test script with the at least one latency period.

In some embodiments, executing the computer-readable code is further configured to cause the at least one processing device to: apply the at least one test script to the at least one software code or the system component; determine a performance of the at least one software code or the system component comprising the test script; generate an alert comprising the performance; and transmit the alert comprising the performance to a user device associated with the at least one software code or the system component and trigger a configuration of a graphical user interface of the user device with the alert.

In some embodiments, executing the computer-readable code is further configured to cause the at least one processing device to: identify, by the generative AI engine, at least one difference between a testing environment and a production environment associated with the at least one software code or the system component; and update, by the generative AI engine, the at least one test script with the at least one difference. In some embodiments, executing the computer-readable code is further configured to cause the at least one processing device to: generate, by the generative AI engine, a simulation of the at least one difference for the test script, wherein the simulation comprises a network environment of the at least one software code or the system component; and apply the test script to the simulation and test the test script for each difference. In some embodiments, executing the computer-readable code is further configured to cause the at least one processing device to: determine, by the generative AI engine, a load capacity of the software code or the system component based on the application of the test script to the simulation; determine, based on the load capacity, a load balance maximum for the at least one software code or the system component; and dynamically update a load balance of the at least one software code or the system component in a production environment based on the load balance maximum.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for a generation of automated testing tools for software applications, in accordance with an embodiment of the disclosure;

FIG. 2 illustrates an exemplary generative AI subsystem, in accordance with an embodiment of the disclosure;

FIG. 3 illustrates a process flow for a generation of automated testing tools for software applications, in accordance with an embodiment of the disclosure;

FIG. 4 illustrates a process flow for updating the test script with a latency period, in accordance with an embodiment of the disclosure;

FIG. 5 illustrates a process flow for generating and transmitting an alert to a user device associated with the software code or the system component based on a performance of the software code with the test script, in accordance with an embodiment of the disclosure; and

FIG. 6 illustrates a process flow for dynamically updating a load balance of the software code or the system component based on the generative AI engine generated load balance maximum, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's world of software applications and electronic devices to complete everyday tasks and activities, making sure those software applications and electronic devices are operating correctly and efficiently is of utmost importance. In order to make sure these software applications and devices are working optimally; test script files are generated to test these applications and devices both before they enter a production environment and continuously after the application has been introduced to production. One major pitfall with these test script files are their inability to accurately simulate the real-world production environment that the application and device are actually in use, and thus, these test script files fail to test the applications and devices for real-world issues each will face which in turn leads to the applications and devices performing non-optimally or not at all in the real-world environments. Thus, there exists a great need for a system, computer program product, and/or computer implemented method that can efficiently, automatically, and dynamically generate these test scripts to be as close to these real-world production environments as possible. Thus, and in other words, time and computing resources can be overused in generating test scripts for applications and programs. Typically, these test scripts are manually generated and too much data and information need to be considered across multiple, disparate sources to generate these test scripts which are specific to each tested application.

Accordingly, the present disclosure provides for the collection of software code data associated with at least one software code or system component comprising the at least one software code; the application of the software code data to a generative artificial intelligence (AI) engine; the generation, by the generative AI engine, of connections between the software code data; and the generation, based on the connections between the software code data and by the generative AI engine, of at least one test script for the at least one software code or the system component, wherein the test script file comprises an end-to-end test for the software code and associated software programs connected to the software code. Additionally, and in some embodiments, the disclosure may provide for the determination of a latency period of the software code and/or the system component, and updating of test script based on this real-world latency period. Further, and in some embodiments, the disclosure may provide for the automatic identification of differences between the testing environment and the production environment; the updating of the test script based on these differences, which may be based on generating a simulation of the differences and applying the simulation to the test script. Based on this simulation, the disclosure may determine a maximum load capacity of the software code and/or the system component in the real-world environment, based on testing the software code and/or system component in the test environment and increasing the test environment's load balance until the software code and/or system component cannot perform.

Thus, and in other words, the disclosure provides a system comprising a generative AI engine which is configured to collect and analyze data from at least a plurality of disparate data sources (e.g., software development, user stories/experiences, current test packs, production data, and/or production support issues). The generative AI engine may analyze each of these data sources, make connections between the data sources, to systematically create and test cases or remove the test cases that are no longer needed. In this manner, the generative AI engine may generate the test cases in not just a singular view of the code, but the code's end-to-end intersection among all codes that may connect to the original code and their production data. Additionally, the generative AI engine may analyze and account for drifts and latency between components, data centers, and/or the like, which may each run the application or affect the application's run time and outcomes, and such drifts and latency data may be built into these test scripts. Further, and by emulating real-life environments in these test scripts, the system may send automated alerts for the applications, components, data centers, and/or the like that are performing the worst in these real life conditions.

What is more, the present disclosure provides a technical solution to a technical problem. As described herein, the technical problem includes the automatic generation of test scripts based on real time and near real time data of how software code and/or system components are performing in a real-world environment. The technical solution presented herein allows for the automatic and dynamic generation of test scripts in real time or near real time to determining performance data/software code data of the software code and/or system components in a real-world production environment. In particular, the present disclosure is an improvement over existing solutions to these technical problems, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

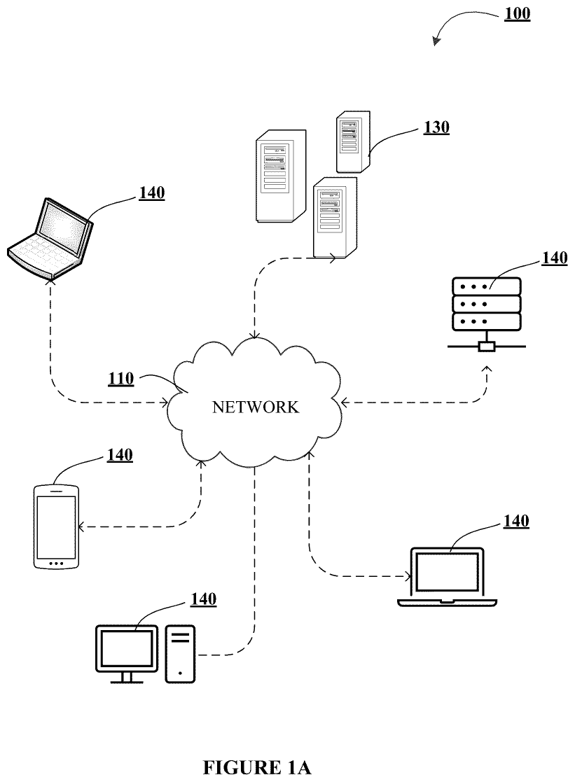

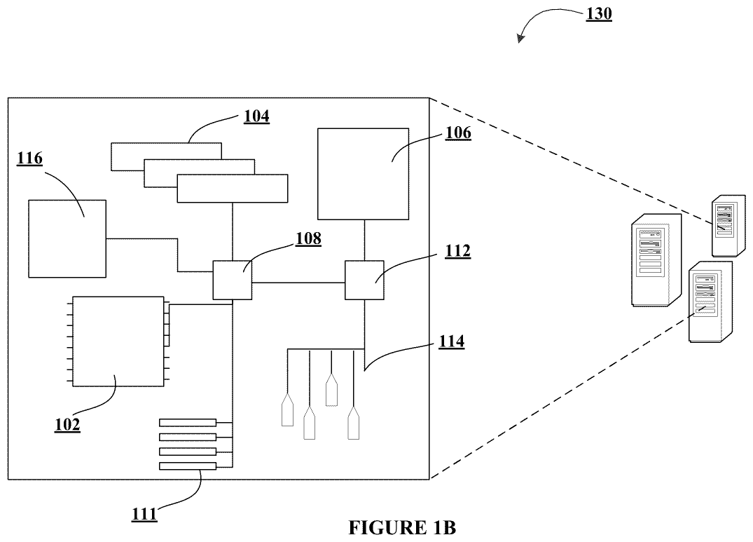

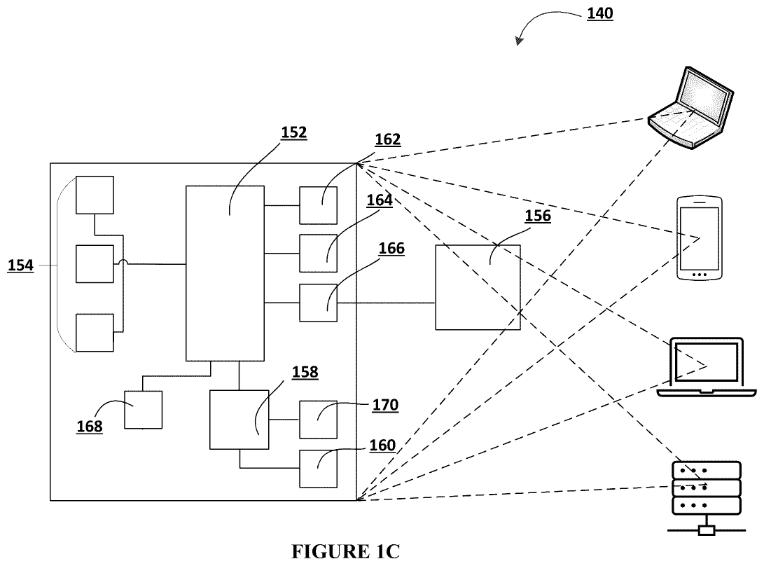

FIGS. 1A-1C illustrate technical components of an exemplary distributed computing environment for a generation of automated testing tools for software applications 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

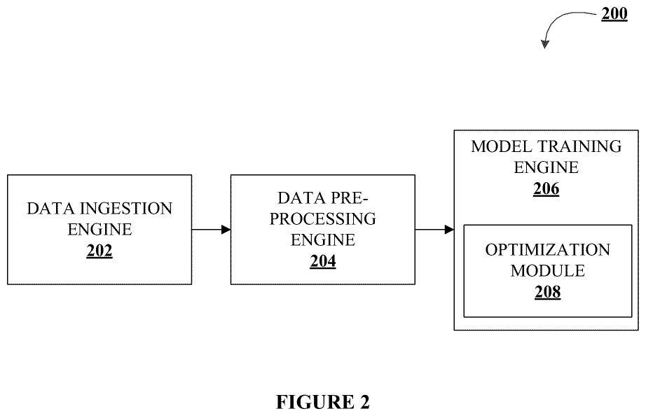

FIG. 2 illustrates an exemplary generative AI subsystem/engine 200, in accordance with an embodiment of the invention. The generative AI subsystem/engine 200 may include a data ingestion engine 202, a data pre-processing engine 204, and a model training engine 206. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 202 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 200 may utilize one or more machine learning techniques to generate new content. In machine learning, the quality of data and the useful information that may be derived therefrom directly affects the ability of the machine learning model to learn. The data pre-processing engine 204 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that may be suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training engine 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data may be used to update the model's parameters, while the validation and testing datasets may be reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206, which includes an optimization module 208, may implement various optimization techniques to improve model performance and efficiency. The optimization module 208 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 208 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

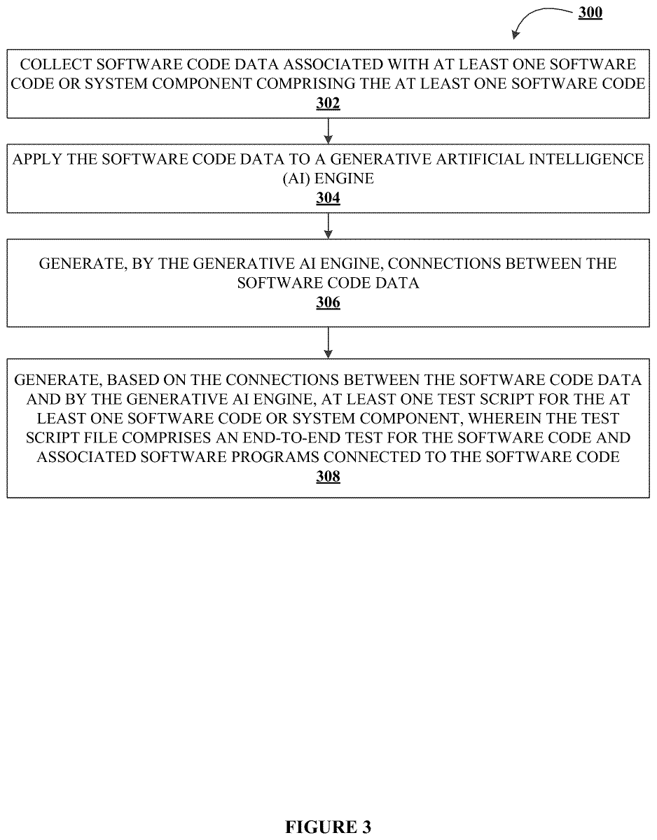

FIG. 3 illustrates a process flow 300 for a generation of automated testing tools for software applications, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

As shown in block 302, the process flow 300 may include the step of collecting software code data associated with at least one software code or system component comprises the at least one software code. For instance, the system may collect software code data indicating data of a software application, such as but not limited to a software application identifier, a performance or production data of the software application at a current time or immediate previous time (e.g., specific information on the performance of the application, a pass or fail indicator), a purpose or intent of the application, an operating system of the application, a system component identifier where the application is stored or used (such as a data center identifier, a server identifier, and/or the like), the expected output of the application, the actual output of the application, and/or the like. In some embodiments, the software code data may comprise the data needed to generate a test script for the file, which may comprise but is not limited to a unique test identifier for the current test script file on the application, a descriptive test name for the current test script file, detailed steps to execute the test (for the test script to perform correctly), the expected results for each step, any necessary test data, pre-conditions, post-conditions, the performance of the application after the current test script (e.g., pass/fail), and/or the like.

Additionally, and in some embodiments, the system may collect software code data from an identified software application (e.g., a software application comprising the software code) and/or a system component (e.g., a data center, a server, a mobile device, a tablet, a personal computer, and/or the like). For example, and in some embodiments, the system may receive a software application identifier from a user device associated with the system and the software application (e.g., a user device associated with a user account identifier that operates or manages the software application and/or the system component the software application is implemented on), and the software application identifier may comprise a request to generate a new or optimized test script file using the process(es) described herein. Additionally, and/or alternatively, the system itself may identify the software application and/or the system component that needs the optimized test script file to be generated and run on the software application or system component by analyzing each of the software applications running in the system's network and determining which software applications are failing in their performance metrics (not performing properly, are performing at a long latency period or lag time, are not performing at all, and/or the like). In some embodiments, the analysis of the software applications running in the system's network may comprise collecting production data (or performance data) on how the software applications are actually performing in a real world environment. Those applications that are not performing well or at all may be identified by the system and formatted into a list of software applications that need optimzied test scripts to be generated using the process(es) described herein. In some such embodiments, the list of software applications may be used by the system as a guide for which applications and their software code data to collect in a systematic manner (e.g., the system may go down the list of software applications and collect the software code data for each software application identifier in chronological order). In some embodiments, the list may be sorted based on chronology of when the software application was identified as having an issue, or based on severity of the problem with the software application (where the most severe applications will be listed first).

Further, and in some embodiments, the software code data may be collected from a plurality of disparate software code sources. For instance, such disparate software code sources may comprise a production data source where production data may be collected, a software development source where software development data may be collected, user experience data from a database or repository of user experience, a test script data source where current test script data may be collected, a production support data source where productions support data may be collected, and/or the like. In some embodiments, the software code data collect may comprise production data, user experience data, software development data, test script data, and production support data. Alternatively, and in some embodiments, the software code data collected may comprise one or more of the production data, software development data, test script data, or production support data.

For example, such production data may refer to the real-world data that is used by the software application in real-world environment, and such production data may comprise actual user interactions, actual inputs and outputs, system component behaviors, and other such data that the software application is processing and storing while being used in a real-world production environment with real-world interactions and user inputs. In some such embodiments, the system may collect the production data from a production data source such as from one or more sensors, Internet of Things (IoT) devices, scanners, data collection applications, direct user inputs, and/or the like.

In some embodiments, the software code data may comprise software development data, which may be collected from a software development source such as the intent behind the application, sample data, intended inputs and outputs of the application, and other such data used by the software application developers during the design and coding phase, and/or the like. Such software development data may be collected from logs generated during the design and coding phase which may have been generated manually by the development team, comments within the code of the software application, sample data used in the development phase, and/or the like. In some embodiments, the software development data may be automatically collected and input to a development database associated with the software application.

In some embodiments, the software code data may comprise user experience data which may be collected from a user experience database, whereby the user experience database may comprise information and/or data regarding real-world user experiences with the software code, an application comprising the software code, a system component comprising the software code, and/or the like. In some embodiments, the user experience database may be stored external or internal to the application or system component comprising the software code.

In some embodiments, the software code data may comprise test script data which may be collected from a test script data source comprising external data sources from the current test script, such as but not limited to test script databases, repositories, and/or the like. In some such embodiments, the test script data may comprise a current test script identifier, specific data sets that test one or more scenarios or purposes in the software application, current instructions written in the same programming language as the application being test, and/or the like.

In some embodiments, the software code data may comprise production support data which may be collected from a production support data source comprising internal sources to the application such as application logs, system monitoring tools, databases, user interface interactions, application programming interface (API) calls, system performance metrics, and/or the like. In some such embodiments, the production support data may comprise data collected from the production (real-world) environment such as error logs, response times, issues with external systems and their integration with the application (e.g., API call problems), query performance, data integrity checks, database errors, CPU usage, key performance indicators, memory utilization, network traffic, system metrics, user feedback, and/or the like.

As shown in block 304, the process flow 300 may include the step of applying the software code data to a generative artificial intelligence (AI) engine. For instance, the system may apply the collected software code data to a generative AI engine (like the generative AI engine shown and described above with respect to FIG. 2), and the generative AI engine may generate connections and determine patterns between each of the collected software code for each software code analyzed. In some embodiments, the generative AI engine may be configured to generate a map comprising nodes and edges, whereby the nodes may indicate software code data processed by the generative AI engine. In some embodiments, the generative AI engine may determine patterns and gaps in the functioning of the software code by learning patterns based on the software code data, such as by integrating the newly collected software data code into the generative AI engine's knowledge graphs, databases, repositories, and/or the like.

As shown in block 306, the process flow 300 may include the step of generating, by the generative AI engine, connections between the software code data. For example, and in some embodiments, the generative AI engine may generate a map comprising nodes of each piece of software code data and edges indicating each relation between the nodes of the software code data with respect to the underlying software application and how the software application is currently performing in its production environment as compared to its intended purpose. In this manner, and based on the connections generated by the generative AI engine, the generative AI engine may determine any gaps between the nodes indicated by the software code data that has not been addressed or fixed (e.g., has a connecting node via at least one edge), and may thus, determine where gaps in the performance of the application are present. Thus, and by comparing the connections between each of the software code data, the generative AI engine may generate a holistic and full view of how the software code is currently performing with respect to its intended functions, and with respect to other related software code and applications that may receive data from the original software code being analyzed by the generative AI engine. Based on this holistic view, the generative AI engine may generate a new and optimized test script for the software code that can train for these real-world gaps identified by the generative AI engine and test for further unknown issues that may be unacceptable or may be unknowingly/unintentionally slowing down the entire processing speed of the software code.

As shown in block 308, the process flow 300 may include the step of generating, based on the connections between the software code data and by the generative AI engine, at least one test script for the at least one software code or the system component, wherein the test script file comprises an end-to-end test for the software code and associated software programs connected to the software code. For instance, the system may generate—using the connections between the software code data—at least one test script file that is holistic (i.e., an end-to-end test script file for the instant software code and the other software code that receives data from or sends data to the instant software code and/or the other system components that are affected by the instant software code and its inputs/outputs). Thus, and in some such embodiments, the test script file generated may comprise an end-to-end test for the software code and associated software programs connected to the software code. Such software programs may be located internal or external to the network associated with the instant software code. As used herein, the terms “test script” and “test script file” may be used interchangeably to refer to an automated software testing comprising a set of computer-readable instructions to determine how the application, software code, system component, and/or the like, performs and functions under the testing conditions, which may mimic a real-world environment.

In some embodiments, the system may generate the test script file using the generative AI engine, which may have been pre-trained with historical test scripts used on the same application, software code, system component, and/or the like, or on similarly used or similarly situation applications, software codes, system components, and/or the like. Further, and using historical software code data (such as but not limited to historical production data, historical software development data, historical user experience data, historical test script data, and historical production support data, and/or the like.

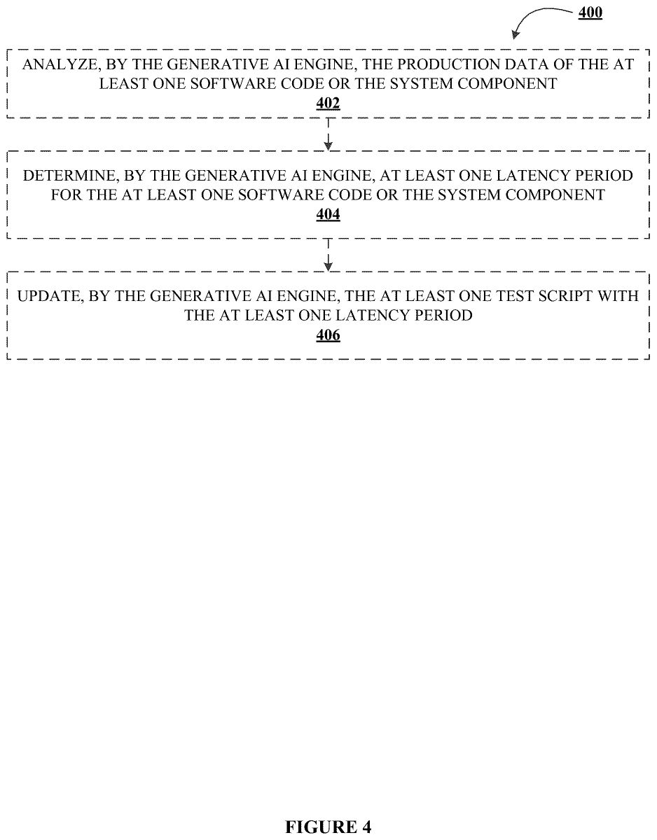

FIG. 4 illustrates a process flow 400 for updating the test script with a latency period, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of analyzing, by the generative AI engine, the production data of the at least one software code or the system component. For example, the system may process and/or analyze—using the generative AI engine—the production data of the software code and/or the system component comprising the software code. In some such embodiments, the system may parse the production data, and analyze each piece of production data individually and/or holistically. In some embodiments, the generative AI engine may generate a knowledge graph comprising the production data indicated as nodes, and may generate edges between each node indicating the production data to analyze the difference between each piece of production data. For instance, and where the production data analyzed by the generative AI engine for the software code comprises production data over the holistic or complete process of the software code, such as where the software code may comprise two backup datacenters running the software code and a latency or lag exists between each data center, then the generative AI engine may analyze the differences (e.g., latency) between each node indicating the production data (e.g., each node may indicate a first data center and a second data center, and the edges may indicate the time response or lag between each data center's node). In this manner, the generative AI engine may generate a complete view of how the software code works in its overall environment(s), as the software code is run in the real-world and multiple system components are used or affected by the software code.

In some embodiments, and as shown in block 404, the process flow 400 may include the step of determining, by the generative AI engine, at least one latency period for the at least one software code or the system component. For example, and in some embodiments, the system may determine the lag or latency as the software code runs within a singular application or system component, and/or as the software code runs within multiple applications or system components. Such a lag or latency may refer to the delay in time between the software code having its required input (e.g., a user input, a system generated input, and/or the like), and an output or response from the software code (which could manifest as a response or change in conditions for a system component comprising the software code, such as the turning on of the system component or running a process on the system component). In some embodiments, the latency may comprise a network latency (across different system components, such as delays in transmission across a network), system latency (a delay intime for processing and responding to an input), application latency (a delay in time between a user's action and the software code or system component's response), and/or the like. In some embodiments, the latency may be measured in milliseconds, seconds, minutes, and/or the like.

Thus, and in some such embodiments, the generative AI engine—based on processing the production data of the software code and/or the system component(s)—may determine at least one latency period for the at least one software code and/or the system components. In some embodiments, the generative AI engine may indicate the latency period between the production data nodes as the edges between the nodes in the knowledge graph.

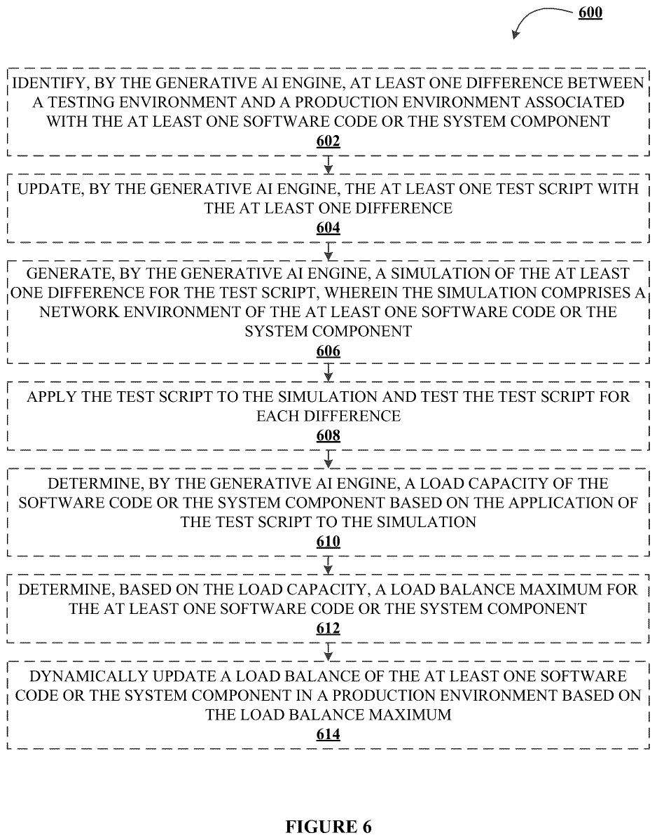

In some embodiments, and as shown in block 406, the process flow 400 may include the step of updating, by the generative AI engine, the at least one test script with the at least one latency period. For example, and in some embodiments, the system may update—using the generative AI engine—the at least one test script with the latency period, such that the test script file is based on real-world events and accounts for the expected latencies between each input and response. Thus, and in other words, the generative AI engine may analyze and account for drifts and latency between components, data centers, and/or the like when generating the test script, so the test script is a real-life embodiment of what is actually occurring. In this manner, the test script may run on the software code which may be run within the associated application or system component and affect the application's run time and outcomes, and such drifts and latency data may be built into these test scripts. By way of non-limiting example, a low-level environment may be operated in the same data center on multiple nodes and there may be an inherency lack of latency because the process is running at the same datacenter, but in an instance where site resiliency and data center resiliency are built in (e.g., the software code is running in at least two data centers) and the latency between those data centers is 100 milliseconds which should be fed into the test script file to update the test script file to create a real-world testing environment. In this manner, and by generating a test script file that is as close to a real-world environment as possible, the system is able to pinpoint more important issues that may go beyond a small latency issue that was not already accounted for in previous test cases. Thus, the time to identify these more important issues are drastically reduced and alerts may be generated that point to their issues before the application goes into production or in order to update the application as quickly as possible. Additionally, and in some embodiments, by generating these optimzied test script with real-world scenarios, the system may further be able to identify production parameters that allow the software code and the system components to function at their highest levels (e.g., their highest loads) without undergoing performance issues or slowdowns. Such an embodiment is further described below with respect to FIG. 6.

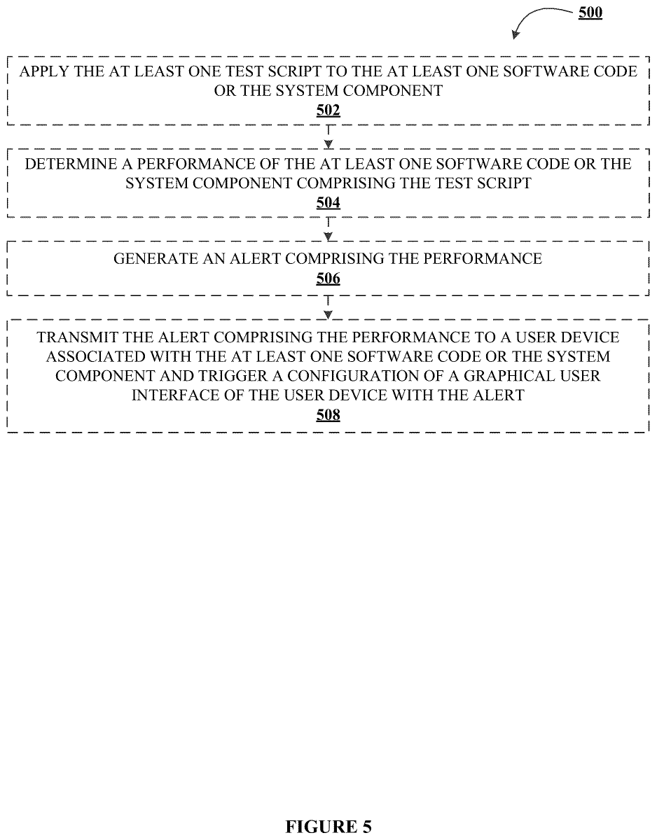

FIG. 5 illustrates a process flow 500 for generating and transmitting an alert to a user device associated with the software code or the system component based on a performance of the software code with the test script, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step applying the at least one test script to the at least one software code or the system component. For example, and in some such embodiments, the system may apply the at least one test script generated in FIG. 3 to the at least one software code, an application comprising the software code, and/or the system component associated with or comprising the software code. Based on this application of the generated test script to the software code and/or the system component, the system may determine how the software code, the application comprising the software code, and/or the system code performs with the test script.

In some embodiments, and as shown in block 504, the process flow 500 may include the step of determining a performance of the at least one software code or the system component comprising the test script. For instance, and in some such embodiments, the system may determine how the software component, the application, and/or the system component is performing during test. In some embodiments, the performance may be measured as a pass or fail depending on the data collected during testing (such as the test script data). In some embodiments, the performance data may comprise response time within the software code and/or outside the software code at different applications and/or different system components. In some embodiments, the performance data may comprise data indicating important and/or severe problems are occurring during the testing, and thus, the software code, application comprising the software code, and/or the system component may not perform correctly, well, and/or at all in the production environment. In some such embodiments, and by applying the optimzied test script comprising the real-world environment in a safe way (through the test script, the system can determine all the potential severe problems that may actually occur in the real world production environment and can isolate them to generate alerts which can be used for further investigation and problem-solving. In this manner, the system can avoid generating alerts for every issue that the software code may face, even those that are expected in the test script (e.g., expected latency or lag time, and/or the like).

Additionally, and importantly, by generating these real-life test scripts that simulate the real-world production environment the software code, application, and/or system component will face, the system can ensure that—when an update is released to the software code—the updated software code can overcome these identified real-world problems in the testing environment before the updated software component goes through the production phase. Thus, and by generating these real-world test scripts, the system can improve processing speed, network communications, and any other such problems faced by software codes, applications, and/or system components pro-actively and before potential users, potential devices, potential networks, and/or the like face the problems in the real world.

In some embodiments, and as shown in block 506, the process flow 500 may include the step of generating an alert comprising the performance. For example, and in some embodiments, the system may generate an alert (i.e., an alert interface component), which may comprise the performance data and information determined in block 504 for the software code, the application, the system component, and/or the like. Thus, and in some such embodiments, the alert interface component may comprise at least the performance data and the software code identifier in a computer-readable data packet, and the alert interface component may be transmitted over a network (such as the network shown in FIG. 1A) to a user device associated with the software code (and/or the application or the system component comprising the software code).

In some embodiments, and as shown in block 508, the process flow 500 may include the step of transmitting the alert comprising the performance to a user device associated with the at least one software code or the system component and trigger a configuration of a graphical user interface (GUI) of the user device with the alert. For instance, and in some such embodiments, the system may transmit the alert to a user device associated with the software code, the application comprising the software code, and/or the system component, whereby the user device may be associated with a user account identifier that has the security access to update the software code, the software library associated with the software code, the system component and its software, the application and its software, and/or the like. In this manner, the system may automatically transmit the alert to an identified user device, and the user of the user device may update the software code to resolve the alert and/or resolve some of the performance problems identified in the performance data. In this manner, the system may send automated alerts for the applications, components, data centers, and/or the like that are performing the worst in the real life conditions. Further, and in some embodiments, by analyzing the performance data, which may comprise one or more of production data, production support data, test script data, incident or error data, and/or the like, the system and the user viewing the alert may focus on particular severe and important areas that have recently been neglected or are recently undergoing the most issues. Thus, and in some such embodiments, the alert—after the transmission to the user device—may automatically trigger a configuration of the user device's GUI to show the performance information to the user interacting with the user device.

FIG. 6 illustrates a process flow 600 for dynamically updating a load balance of the software code or the system component based on the generative AI engine generated load balance maximum, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600.

In some embodiments, and as shown in block 602, the process flow 600 may include the step of identifying, by the generative AI engine, at least one difference between a testing environment and a production environment associated with the at least one software code or the system component. For instance, and in some embodiments, the system may identify one or more differences between the testing environment where the test script is run in the software code, in the system component, and/or the like, and the production environment where the software code and/or system component comprising the software code is actually run in the real-world. In some embodiments, the testing environment may comprise a user acceptance testing (UAT) environment, or the final stage of software testing where users can evaluate the software code and/or the system component to determine it fits their purpose. In some embodiments, the testing environment may comprise parameters, rules, and/or the like, and/or specific data packets for testing, that the production environment will not have. Thus, and in some such embodiments, the system may identify each of these differences and update—using the generative AI engine—the test script to account for these differences within the testing environment.

In some embodiments, and as shown in block 604, the process flow 600 may include the step of updating, by the generative AI engine, the at least one test script with the at least one difference. Thus, and as described briefly above, the system may update the test script with the differences identified between the test environment and the production environment, such that the differences that the test script can get the software code to perform in as close to the real-world production environment (in the testing environment) as possible. In some embodiments, the differences may comprise different parameters or rules in the production environment being applied to the test script, or different data sets or user inputs from the production environment being applied as the test dataset in the test environment, and/or the like. Thus, and in other words, the generative AI engine—by updating the test script with these differences—can emulate or fill in the gaps to feed in the difference data into the test script/test analysis for a test environment that can be as close to the real-world environment as possible.

In some embodiments, and as shown in block 606, the process flow 600 may include the step of generating, by the generative AI engine, a simulation of the at least one difference for the test script, wherein the simulation comprises a network environment of the at least one software code or the system component. For example, and in some such embodiments, the system may generate—using the generative AI engine—a simulation of the differences for the test script, whereby the simulated differences may be used to update the test script such that the simulation is a full and complete view of each difference and how they are used or perform in the production environment. For instance, the differences may indicate the environment the software code is going to run in within the production environment, and any network transmissions that will occur during the running of the software code in the production environment, and the generative AI engine may then generate the simulation to show each of the characteristics of the network environment that the software code runs in at each instance.

In some embodiments, and as shown in block 608, the process flow 600 may include the step of applying the test script to the simulation and test the test script for each difference. Additionally, and upon generating the simulation according to the production environment, the system may apply the test scrip to the simulation to test whether the test script has any of the differences already built in or if it doesn't, which differences need to be built in. Thus, and in some embodiments, the test script's gaps may be filled in by applying the simulation to the test script and updating the test script with any differences that can be used within the test script's data, parameters, and/or the like.

In some embodiments, and as shown in block 610, the process flow 600 may include the step of determining, by the generative AI engine, a load capacity of the software code or the system component based on the application of the test script to the simulation. For instance, and in some embodiments, the system may use the generative AI engine to determine a load capacity of the software code and/or the system component comprising the software code (e.g., a load balance of a datacenter, a load balancer, a server, a central processing unit, and/or the like). Thus, and in some such embodiments, the generative AI engine may determine—by applying the updated test script (updated based on the simulation) to the software code—a real-world load balance of the software code within the testing environment. Such a real-world load balance may indicate the current load balance of the software code and/or the system component based on the test script that is modeled after the real-world production environment.

In some embodiments, and as shown in block 612, the process flow 600 may include the step of determining, based on the load capacity, a load balance maximum for the at least one software code or the system component. Thus, and in some such embodiments, the system may determine—using the generative AI engine—the maximum level of the load balance of the software code that the software code can go (e.g., without the software code failing or undergoing strain that causes performance issues or latency issues). Thus, and in some embodiments, the system may continuously update and increase the load balance within the test script that is applied to the software code until the software code fails or almost fails. Based on this increase of the load balance until the software code fails, in the testing environment, the system may determine an actual maximum load balance the software code would come the closest to failing in the real-world production environment.

In some embodiments, and as shown in block 614, the process flow 600 may include the step of dynamically updating a load balance of the at least one software code or the system component in a production environment based on the load balance maximum. For example, and in some such embodiments, the system may dynamically and automatically update the load balance in the real-world production environment based on the identified load balance maximum. In other words, the system is able to create real-life scenarios, leveraging characteristics in real time or near real time to collecting the software code data, and updating the test script based on these characteristics to test how the software code will actually perform in the production environment. Thus, and with respect to an embodiment where the system is determining the maximum load balance, the system may determine the current load balance and further, determine what load the software component can be ramped up to without allowing the software code to perform worse or not at all.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for a generation of automated testing tools for software applications, the system comprising:
a memory device with computer-readable program code stored thereon;
at least one processing device operatively coupled to the memory device and at least one communication device, wherein executing the computer-readable code is configured to cause the at least one processing device to:
collect software code data associated with at least one software code or system component comprising the at least one software code;
apply the software code data to a generative artificial intelligence (AI) engine;
generate, by the generative AI engine, connections between the software code data; and
generate, based on the connections between the software code data and by the generative AI engine, at least one test script for the at least one software code or the system component, wherein the test script file comprises an end-to-end test for the software code and associated software programs connected to the software code.

2. The system of claim 1, wherein the software code data is collected from a plurality of disparate software code sources.

3. The system of claim 1, wherein the software code data comprises production data, software development data, user experience data, current test script data, and production support data.

4. The system of claim 1, wherein the software code data comprises production data, wherein executing the computer-readable code is further configured to cause the at least one processing device to:
analyze, by the generative AI engine, the production data of the at least one software code or the system component;
determine, by the generative AI engine, at least one latency period for the at least one software code or the system component; and
update, by the generative AI engine, the at least one test script with the at least one latency period.

5. The system of claim 1, wherein executing the computer-readable code is further configured to cause the at least one processing device to:
apply the at least one test script to the at least one software code or the system component;
determine a performance of the at least one software code or the system component comprising the test script;
generate an alert comprising the performance; and
transmit the alert comprising the performance to a user device associated with the at least one software code or the system component and trigger a configuration of a graphical user interface of the user device with the alert.

6. The system of claim 1, wherein executing the computer-readable code is further configured to cause the at least one processing device to:
identify, by the generative AI engine, at least one difference between a testing environment and a production environment associated with the at least one software code or the system component; and
update, by the generative AI engine, the at least one test script with the at least one difference.

7. The system of claim 6, wherein executing the computer-readable code is further configured to cause the at least one processing device to:
generate, by the generative AI engine, a simulation of the at least one difference for the test script, wherein the simulation comprises a network environment of the at least one software code or the system component; and
apply the test script to the simulation and test the test script for each difference.

8. The system of claim 7, wherein executing the computer-readable code is further configured to cause the at least one processing device to:
determine, by the generative AI engine, a load capacity of the software code or the system component based on the application of the test script to the simulation;
determine, based on the load capacity, a load balance maximum for the at least one software code or the system component; and
dynamically update a load balance of the at least one software code or the system component in a production environment based on the load balance maximum.

9. A computer program product for a generation of automated testing tools for software applications, wherein the computer program product comprises at least one non-transitory computer-readable medium having computer-readable program code portions embodied therein, the computer-readable program code portions which when executed by a processing device are configured to cause the processor to:
collect software code data associated with at least one software code or system component comprising the at least one software code;
apply the software code data to a generative artificial intelligence (AI) engine;
generate, by the generative AI engine, connections between the software code data; and
generate, based on the connections between the software code data and by the generative AI engine, at least one test script for the at least one software code or the system component, wherein the test script file comprises an end-to-end test for the software code and associated software programs connected to the software code.

10. The computer program product of claim 9, wherein the software code data is collected from a plurality of disparate software code sources.

11. The computer program product of claim 9, wherein the software code data comprises production data, software development data, user experience data, current test script data, and production support data.

12. The computer program product of claim 9, wherein the software code data comprises production data, and wherein the computer-readable program code portions which when executed by the processing device are configured to cause the processor to:
analyze, by the generative AI engine, the production data of the at least one software code or the system component;
determine, by the generative AI engine, at least one latency period for the at least one software code or the system component; and
update, by the generative AI engine, the at least one test script with the at least one latency period.

13. The computer program product of claim 9, and wherein the computer-readable program code portions which when executed by the processing device are configured to cause the processor to:
apply the at least one test script to the at least one software code or the system component;
determine a performance of the at least one software code or the system component comprising the test script;
generate an alert comprising the performance; and
transmit the alert comprising the performance to a user device associated with the at least one software code or the system component and trigger a configuration of a graphical user interface of the user device with the alert.

14. The computer program product of claim 9, and wherein the computer-readable program code portions which when executed by the processing device are configured to cause the processor to:
identify, by the generative AI engine, at least one difference between a testing environment and a production environment associated with the at least one software code or the system component; and
update, by the generative AI engine, the at least one test script with the at least one difference.

15. A computer implemented method for a generation of automated testing tools for software applications, the computer implemented method comprising:
collecting software code data associated with at least one software code or system component comprising the at least one software code;
applying the software code data to a generative artificial intelligence (AI) engine;
generating, by the generative AI engine, connections between the software code data; and
generating, based on the connections between the software code data and by the generative AI engine, at least one test script for the at least one software code or the system component, wherein the test script file comprises an end-to-end test for the software code and associated software programs connected to the software code.

16. The computer implemented method of claim 15, wherein the software code data is collected from a plurality of disparate software code sources.

17. The computer implemented method of claim 15, wherein the software code data comprises production data, software development data, user experience data, current test script data, and production support data.

18. The computer implemented method of claim 15, wherein the software code data comprises production data, further comprising:
analyzing, by the generative AI engine, the production data of the at least one software code or the system component;
determining, by the generative AI engine, at least one latency period for the at least one software code or the system component; and
updating, by the generative AI engine, the at least one test script with the at least one latency period.

19. The computer implemented method of claim 15, further comprising:
applying the at least one test script to the at least one software code or the system component;
determining a performance of the at least one software code or the system component comprising the test script;
generating an alert comprising the performance; and
transmitting the alert comprising the performance to a user device associated with the at least one software code or the system component and trigger a configuration of a graphical user interface of the user device with the alert.

20. The computer implemented method of claim 15, further comprising:
identifying, by the generative AI engine, at least one difference between a testing environment and a production environment associated with the at least one software code or the system component; and
updating, by the generative AI engine, the at least one test script with the at least one difference.
